(19) United States
(12) Patent Application Publication
(10) Pub. No.: US 2026/0028039 A1
(43) Pub. Date: Jan. 29, 2026

(54) SYSTEMS AND METHODS FOR CONTROLLING QUALITY IN PLANNING A TRAJECTORY OF AN AUTONOMOUS VEHICLE

(71) Applicant: Torc Robotics, Inc., Blacksburg, VA (US)

(72) Inventor: Mihir Deshingkar, Austin, TX (US)

(21) Appl. No.: 18/781,654

(22) Filed: Jul. 23, 2024

(51) Int. Cl. B60W 60/00; G06F 11/34

(52) U.S. Cl. CPC B60W 60/001; G06F 11/3476

(57) ABSTRACT

An autonomy computing system of an autonomous vehicle for controlling quality in planning a trajectory of the autonomous vehicle is provided. The at least one processor of the autonomy computing system is programmed to process sensor data received from one or more sensors of an autonomous vehicle, and generate a trajectory of the autonomous vehicle based on the sensor data and a plurality of rules. At least one of the plurality of rules corresponds to at least one of a plurality of costs. The at least one processor is further programmed to generate a log of violations of the plurality of rules at one or more nodes along the trajectory, and transmit the log over a wireless communication channel to a remote computing device. The log includes explanations of the violations in a human readable language.

### TECHNICAL FIELD

The field of the disclosure relates generally to autonomous vehicles and, more specifically, controlling quality in planning a trajectory of an autonomous vehicle.

### BACKGROUND OF THE INVENTION

A trajectory of an autonomous vehicle is generated in real time as the autonomous vehicle travels. The quality of the generated trajectory needs to be closely controlled to ensure safe and efficient operation of the autonomous vehicle. During quality control, the trajectory needs to be evaluated for debugging purposes. Reasons behind selecting a specific trajectory may be roughly ascertained by reviewing the scenarios. Specific reasons at a specific location, however, are difficult to be pinpointed. Accordingly, it is desirable to provide explanations of a trajectory for an autonomous vehicle.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, the disclosed autonomy computing system of an autonomous vehicle for controlling quality in planning a trajectory of the autonomous vehicle includes at least one processor in communication with at least one memory device. The at least one processor is programmed to process sensor data received from one or more sensors of an autonomous vehicle, and generate a trajectory of the autonomous vehicle based on the sensor data and a plurality of rules. At least one of the plurality of rules corresponds to at least one of a plurality of costs. Generate the trajectory further includes analyzing a plurality of nodes in a graph search of the trajectory based on the plurality of rules, and generating the trajectory by minimizing a total cost associated with traversing along the trajectory. The at least one processor is further programmed to generate a log of violations of the plurality of rules at one or more nodes along the trajectory, and transmit the log over a wireless communication channel to a remote computing device. The log includes explanations of the violations in a human readable language.

In another aspect, the disclosed method for controlling quality in planning a trajectory of an autonomous vehicle includes processing sensor data received from one or more sensors of an autonomous vehicle, and generating a trajectory of the autonomous vehicle based on the sensor data and a plurality of rules. At least one of the plurality of rules corresponds to at least one of a plurality of costs. Generating the trajectory further includes analyzing a plurality of nodes in a graph search of the trajectory based on the plurality of rules, and generating the trajectory by minimizing a total cost associated with traversing along the trajectory. The method further includes generating a log of violations of the plurality of rules at one or more nodes along the trajectory, and transmitting the log over a wireless communication channel to a remote computing device. The log includes explanations of the violations in a human readable language.

In yet another aspect, the disclosed one or more non-transitory machine-readable storage media for controlling quality in planning a trajectory of an autonomous vehicle include a plurality of instructions stored thereon that, in response to being executed, cause a system to process sensor data received from one or more sensors of an autonomous vehicle, and generate a trajectory of the autonomous vehicle based on the sensor data and a plurality of rules. At least one of the plurality of rules corresponds to at least one of a plurality of costs. Generating the trajectory further includes analyzing a plurality of nodes in a graph search of the trajectory based on the plurality of rules, and generating the trajectory by minimizing a total cost associated with traversing along the trajectory. The plurality of instructions further cause the system to generate a log of violations of the plurality of rules at one or more nodes along the trajectory, and transmit the log over a wireless communication channel to a remote computing device. The log includes explanations of the violations in a human readable language.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic diagram of an autonomous vehicle;

FIG. 2 is a block diagram of an autonomous vehicle;

FIG. 3 is a schematic diagram of a graph search for a trajectory of the autonomous vehicle shown in FIGS. 1 and 2;

FIG. 4 is a flow chart of an example method of controlling quality in planning a trajectory of an autonomous vehicle shown in FIGS. 1-3; and

FIG. 5 is a block diagram of an example computing device.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing. The drawings are not to scale unless otherwise noted.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

The disclosed systems and methods are described, for clarity, using certain terminology when referring to and describing relevant components within the disclosure. Where possible, common industry terminology is employed in a manner consistent with its accepted meaning. Unless otherwise stated, such terminology should be given a broad interpretation consistent with the context of the present application and the scope of the appended claims.

Systems and methods of controlling quality in planning a trajectory of an autonomous vehicle are provided. Because an autonomous vehicle relies on the trajectory provided in real time while the autonomous vehicle travels, the quality of the planned trajectory needs to be closely controlled. Explanations on why a specific trajectory is selected in various situations, are advantageous in providing information to debug and ensure the quality of the planned trajectory. In known methods of planning a trajectory, explanations are unavailable. Review of the trajectory with the scenarios may provide a speculation of the reasons why a certain trajectory is chosen, but does not provide pinpointed information on what rules are violated at which nodes that cause the specific selection in the trajectory. Explanations are not readily available by examining the computer programming code of trajectory planning, because the programming code may only include a list of rules and priority of the rules. Further, in a graph search, the number of rules and/or the number of nodes may be prohibitively large. In addition, violations of rules may not be apparent by examining a specific node in the trajectory, either, because the triggering of including the specific node into the trajectory over other nodes in the graph may be caused by one of child nodes of those other nodes.

Systems and methods described herein are also advantageous in providing a trajectory based on costs from violations of rules that govern vehicles traveling on the road, thereby reflecting real-life driving situations. In contrast, known search methods for a trajectory do not consider costs from violations of rules.

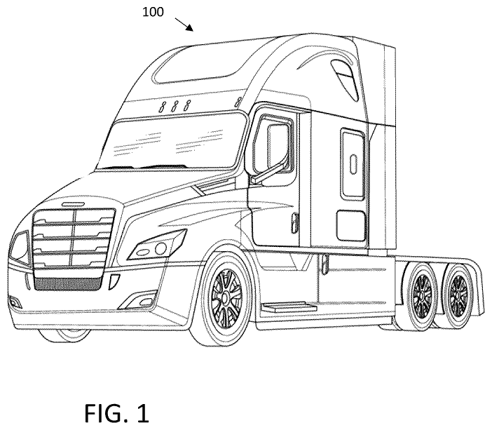

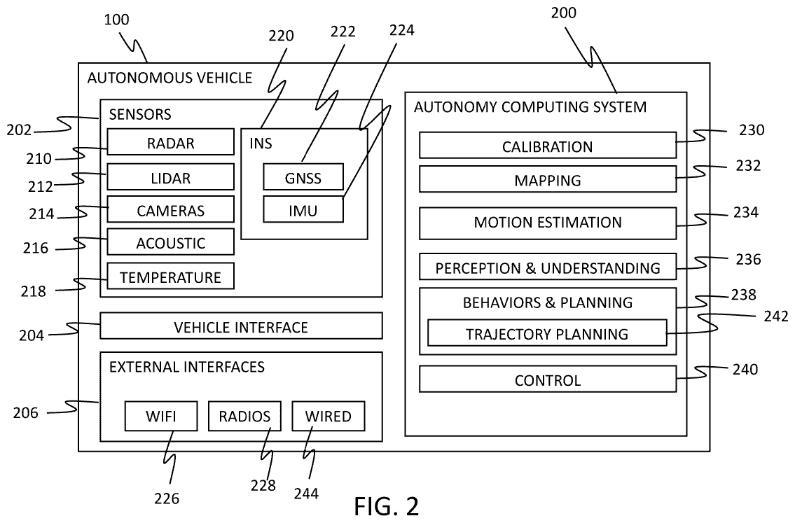

FIG. 1 is a schematic diagram of an autonomous vehicle 100. FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operation of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be stitched or combined to generate a visual representation of the multiple cameras' FOVs, which may be used to, for example, generate a bird's eye view of the environment surrounding autonomous vehicle 100. In some embodiments, the image data generated by cameras 214 may be sent to autonomy computing system 200 or other aspects of autonomous vehicle 100, and this image data may include autonomous vehicle 100 or a generated representation of autonomous vehicle 100. In some embodiments, one or more systems or components of autonomy computing system 200 may overlay labels to the features depicted in the image data, such as on a raster layer or other semantic layer of a high-definition (HD) map.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. Radar sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw radar sensor data) from the emitted radio waves. In some embodiments, the system inputs from cameras 214, radar sensors 210, or LiDAR sensors 212 may be fused or used in combination to determine conditions (e.g., locations of other objects) around autonomous vehicle 100.

GNSS receiver 222 is positioned on autonomous vehicle 100 and may be configured to determine a location of autonomous vehicle 100, which it may embody as GNSS data, as described herein. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, and or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically or manually) via external interfaces 206 or updated on demand. In some embodiments, autonomous vehicle 100 may deploy with all of the data it needs to complete a mission (e.g., perception, localization, and mission planning) and may not utilize a wireless connection or other connection while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, and a trajectory planning module 242. Trajectory planning module 242, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

Trajectory planning module 242 maintains proper lane position for autonomous vehicle 100 in all conditions, e.g., regardless of signage for given road conditions. Trajectory planning module 242 receives, for example, positions of left or right lane markings from perception and understanding module 236 and computes a lane position offset from the identified lane marking. Where both left and right lane markings are detected by perceptions and understanding module 236, in combination with sensors 202, trajectory planning module 242 selects one lane marking from which lane positioning is derived.

Trajectory planning module 242 is further configured to plan a trajectory of autonomous vehicle 100 and control the quality in planning a trajectory. For example, trajectory planning module 242 generates a trajectory. The quality of the trajectory is examined in trajectory planning module 242, such as why a specific trajectory is generated.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

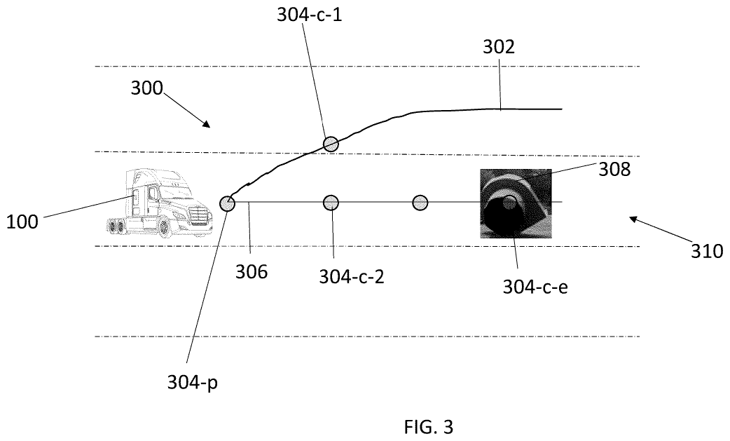

FIG. 3 is a schematic diagram of a graph search 300 for a trajectory 302 of autonomous vehicle 100. An A-star search may be used in graph search 300. An A-star search is a graph search algorithm by finding a path that satisfies conditions of one or more cost constraints. In known A-star search algorithms, the costs between nodes are fixed and costs associated with violations of rules are not considered in the graph search.

In the example embodiments, the sensor data acquired by sensors 202 are processed by autonomy computing system 200 (see FIG. 2). Trajectory planning module 242 (see FIG. 2) is configured to generate a trajectory of autonomous vehicle 100 based on the sensor data and a plurality of rules. Each rule is associated with a cost, which is an assigned value for violating the rule. In some embodiments, a rule may be associated with two or more costs, depending on the scenarios. For example, violating a rule of not hitting an object may have different costs, depending on the object. Hitting a construction cone has a lower cost than hitting a human. In other embodiments, one or more rules in the plurality of rules may not be associated with a cost. At least one of the rules has an associated cost different from another rule among of the plurality of rules. The cost of a rule indicates the priority of the rule. A higher cost indicates the rule having a higher priority, and vice versa. Example rules may be Rule R1 of not hitting an object, Rule R2 of maintaining velocity of the autonomous vehicle, and Rule R3 of staying at the center of the lane. The costs of the rules may be adjusted or finetuned during quality control of trajectory planning module 242.

The trajectory is generated by analyzing a plurality of available nodes 304 in graph search 300 of trajectory 302 based on the plurality of rules. Nodes 304 are points on a graph that may be visited during graph search 300. Nodes 304 are derived based on sensor data, such as points along the roads that autonomous vehicle travels. The trajectory is selected as a path from a starting node, or the starting point of a graph search, to a goal node, or the end point of the graph search, that minimizes a total cost associated with traversing along the trajectory. Trajectory 302 includes a plurality of nodes 304. A node 304 may be associated with a set of violations. Violating a higher priority rule is associated with a higher cost than a lower priority rule. For example, among Rule R1, R2, and R3 listed above, Rule R1 is a higher priority rule than Rule R2, which in turn is a higher priority rule than Rule R3. The total cost of trajectory 302 is determined based on the costs of violations of rules at all nodes 304 along trajectory 302. In one example, the total cost may be the sum of the costs of all nodes 304 along trajectory 302, where a cost of a node is the sum of costs associated with violations of rules by including the node in the trajectory. For example, if selecting node 304 violates Rules R2 and R3 and the cost of violating Rule R2 or R3 is C2 or C3, respectively, the cost of node 304 is the sum of C2 and C3.

In the example embodiment, the graph search is proceeded by searching for a trajectory having a lowest total cost. The graph search progresses to expand the lowest cost node 304 from a pool of currently available nodes in graph search 300. Child nodes 304-c of the lowest cost node 304-p are added to the pool, and denoted as visited nodes. Node 304-p is the parent node of child nodes 304-c-1, 304-c-2. As used herein, a parent node refers generally to a node upstream of another node along a path. A child node refers generally to a node downstream of another node along a path. A path refers generally to a route between nodes, and is not necessary the same as the trajectory selected for the autonomous vehicle. There may be any number of nodes or no node between a parent node and its child node. A node 304 is denoted as visited, when a path 306 reaching node 304 is evaluated and the cost of the path is computed. Trajectory 302 has not expanded to child nodes 304-c of parent node 304-p. At this point, visited nodes 304 are next best alternative paths available in graph search 300. When A-star search reaches the goal node and trajectory 302 is found, nodes that have been visited but not been expanded to be included in trajectory 302 are all next best minimum cost alternatives.

In the example embodiment, at a given node 304-p in trajectory 302, trajectory 302 is typically expanded to a child node that has a lower rule violation, or cost, than other child nodes of the parent node. The graph search algorithm may choose to expand the trajectory to include a child node with a lower priority rule violated, instead of another child node not violating the lower priority rule, only if adhering to the lower priority rule by the other child node results in violation of a higher priority rule by a child node downstream of the other child node. For example, a parent node 304-p has a first child node 304-c-1 and a second child node 304-c-2. At this point, parent node 304-p is in trajectory 302, and to which child node 304-c to expand is to be determined. First child node 304-c-1 has a higher cost than second child node 304-c-2, where first child node 304-c-1 violates rule R2 and R3 while second child node 304-c-2 does not violate any rule. Under most circumstances, trajectory 302 is expanded to include second child node 304-c-2 due to the lower cost. In the depicted situation, however, trajectory 302 is expanded to include first child node 304-c-1 instead, because a downstream child node of second child node 304-c-2 violates a higher priority rule than first child node 304-c-1. Continuing with the example of rules R1, R2, and R3, a node 304-c-1 that violates rules R2 and R3 is chosen to be included in trajectory 302 only if choosing node 304-c-2 that does not violate rules R2 or R3 would result in violation of rule R1. As shown in FIG. 3, an obstacle 308 is in the middle of a lane 310. Rule R1 of not hitting an object has a higher priority than Rule R2 of maintaining velocity of the autonomous vehicle and Rule R3 of staying at the center of lane 310. At parent node 304-p of child nodes 304-c-1, 304-c-2, it is unapparent why first child node 304-c-1 is chosen over second child node 304-c-2, because if examining at parent node 304-p, selecting first child node 304-c-1 violates rules R2 and R3, while selecting second child node 304-c-1 does not violate any rule. The cause of deviation from the general rule of selecting a node having a lower cost is that a downstream child node of second child node 304-c-2, where obstacle 308 locates, violates rule R1 of not hitting an object, which has a higher priority than rules R2 and R3.

Once a trajectory 302 is found, where graph search 300 reaches a goal node, autonomy computing system 200 is configured to iterate through visited nodes 304 in the pool of visited nodes 304 and check which nodes 304 have lower violations of rules or no violation of rules, but lead to violations of higher priority rules. The node 304 that violates the higher priority rule may be referred to as an end child node 304, such as node 304-c-e at which obstacle 308 is located. The algorithm traces from end child node 304 upstream to its parent node 304, its parent's parent node 304, and so on until a parent node 304 is found on trajectory 302. Parent node 304 may be referred to as a common parent node 304, which is the common parent to node 304-c-1 in trajectory 302 and node 304 visited but not selected to be included in trajectory 302. The violations between common parent node 304 and end child node 304 are recorded and used to explain why graph search 300 selects trajectory 302, instead of alternative path 306. For example, as autonomous vehicle 100 drives down a path along lane 310, an obstacle 308 is detected. Trajectory 302 is determined as slowing down and deviating from lane 310, which violates Rule R2 and R3 at node 304-c-1, instead of staying on path 306 and violating rule R1 at node 304-c-e. Node 304-c-2 does not have violations of lower priority rule R2 or R3, but leads to a violation of higher priority rule R1 by its child node 304-c-c. Trajectory planning module 242 is configured to trace along a path 306 from end child node 304-c-e all the way to one of its parents that is common parent node 304-p of child nodes 304-c-1, 304-c-2. Along the tracing back from end child node 304-c-c to common parent node 304-p, explanations as to why node 304-c-1, instead of node 304-c-2, is chosen to be included in trajectory 302 are collected and provided. The explanations may be based on the violations of rules by end child node 304-c-e. The explanations may be in human readable language, such as “selecting a node to avoid violation of a rule of not hitting an object.” The explanations may be displayed next to the selected node 304-c-1 and/or parent node 304-p such that the explanation is pinpointed to a specific node.

For each node 304 on trajectory 302, unique violation sets may be provided. Example violation sets may be minimizing the cost by violating rules R5 and R6 to avoid violating rule R2, or violating rules R5 and R6 to avoid violating rule R3. The violation sets may be combined into a log (not shown). The log may be transmitted to a remote computing device via a wireless communication channel for quality control on the generated trajectory 302. The wireless communication channel may be established via external interfaces 206, such as wi-fi 226 and/or other radios 228. A user may review trajectory 302 with the log to check whether the explanations provided in the log are sensible. In some embodiments, a graph showing trajectory 302 is also transmitted. The graph may be included in the log or separate from the log. The graph may be provided with sensor data, such as images showing environments around autonomous vehicle 100 along trajectory 302. A user may review trajectory 302 with the graph and the log to evaluate whether the selection of trajectory 302 is sensible. If the selection is found insensible, the process of generating a trajectory may be revised or redesigned, such as adjusting the costs of the rules or adding or removing one or more rules.

The explanations may be provided in real time, where the explanations are provided while the autonomous vehicle is traversing the trajectory. Real time explanations are advantageous for debugging the program of planning a trajectory by providing real time feedback on the program in handling real time scenarios. In some embodiments, the explanations are provided in a post-processing package, where a log including the explanations is provided to a user or a developer. A graph and/or sensor data may be provided along with the log or provided in the log. The user may step through the nodes while playing the log, and examine the graph search with the explanations to determine whether the program performs as designed. Providing explanations in post-processing is advantageous in providing time to examine and debug the program in detail. In some embodiments, the log and/or the graph are fed into the program, and the explanations are reviewed side by side with the graph, thereby ensuring the program performs as designed.

Providing explanations are advantageous in providing a quality control tool in examining the program for planning a trajectory. The explanations may be used for debugging the program to ensure the program performs as designed, thereby saving time spent in debugging. The explanations may be used for evaluating adjustments to the program. For example, adjustments may be made with regard to the rules, such as the priority orders of rules and/or costs associated with the rules, adding, removing, and/or changing the rules, to increase the accuracy in reflecting the scenarios faced by the autonomous vehicle. The explanations may be used to evaluate the effectiveness of adjustments. In using the explanations for quality control, if the explanations are insensible in view of the scenarios, the program may be modified, such as correcting programming errors in implementing the algorithm, changing the rules and/or the costs associated with the rules, adjusting the hierarchy of the rules, adding one or more rules, and/or removing one or more rules.

The systems and methods described here are advantageous in providing a quality control of the program for trajectory planning without noticeable detrimental effects on the computation time and/or storage. The computation load from generating explanations on trajectory planning is much less than graph search because costs evaluations of all nodes are not needed. Only a few extra processes, such as tracing back to the parent node and comparing the costs between child nodes, are needed to generate explanations and demand on computation time and/or storage from the extra processes is relatively light, thereby providing explanations without noticeably affecting the operation of the trajectory planning.

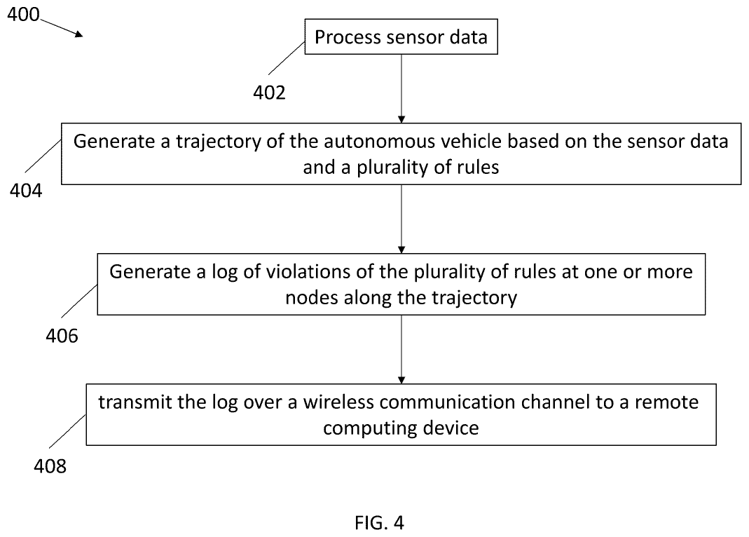

FIG. 4 is a flow chart of an example method 400 of controlling quality in planning a trajectory of an autonomous vehicle. Method 400 may be implemented by autonomy computing system 200 of autonomous vehicle 100. In the example embodiment, method 400 includes processing 402 sensor data received from one or more sensors of an autonomous vehicle. Method 400 also includes generating 404 a trajectory of the autonomous vehicle based on the sensor data and a plurality of rules. At least one of the plurality of rules corresponds to at least one of a plurality of costs. Generating 404 the trajectory may further include analyzing a plurality of nodes in a graph search of the trajectory based on the plurality of rules and generating the trajectory by minimizing a total cost associated with traversing along the trajectory. Method 400 further includes generating 406 a log of violations of the plurality of rules at one or more nodes along the trajectory. The log includes explanations of the violations in a human readable language. In addition, method 400 includes transmitting 408 the log over a wireless communication channel to a remote computing device.

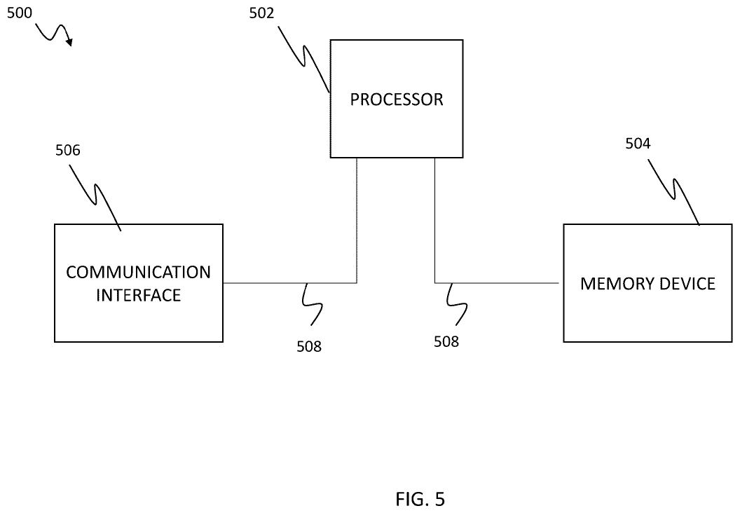

FIG. 5 is a block diagram of an example computing device 500. Autonomy computing system 200 or part of autonomy computing system 200 may be implemented with computing device 500. In the example embodiment, computing device 500 includes a processor 502 and a memory device 504. The processor 502 is coupled to the memory device 504 via a system bus 508. The term “processor” refers generally to any programmable system including systems and microcontrollers, reduced instruction set computers (RISC), complex instruction set computers (CISC), application specific integrated circuits (ASIC), programmable logic circuits (PLC), and any other circuit or processor capable of executing the functions described herein. The above examples are example only, and thus are not intended to limit in any way the definition or meaning of the term “processor.”

In the example embodiment, the memory device 504 includes one or more devices that enable information, such as executable instructions or other data (e.g., sensor data), to be stored and retrieved. Moreover, the memory device 504 includes one or more computer readable media, such as, without limitation, dynamic random access memory (DRAM), static random access memory (SRAM), a solid state disk, or a hard disk. In the example embodiment, the memory device 504 stores, without limitation, application source code, application object code, configuration data, additional input events, application states, assertion statements, validation results, or any other type of data. The computing device 500, in the example embodiment, may also include a communication interface 506 that is coupled to the processor 502 via system bus 508. Moreover, the communication interface 506 is communicatively coupled to data acquisition devices.

In the example embodiment, processor 502 may be programmed by encoding an operation using one or more executable instructions and providing the executable instructions in the memory device 504. In the example embodiment, the processor 502 is programmed to select a plurality of measurements that are received from data acquisition devices.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

An example technical effect of the methods, systems, and apparatus described herein includes at least one of: (a) providing explanations of selecting a trajectory, (b) providing explanations in a human readable language, (c) generating a trajectory by minimizing costs associated with violations of rules, or (d) expanding a trajectory to include a node that violates a lower priority rule than another node only if a child node of another node violates a higher priority rule.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable/machine-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. An autonomy computing system of an autonomous vehicle for controlling quality in planning a trajectory of the autonomous vehicle, comprising at least one processor in communication with at least one memory device, and the at least one processor programmed to:
process sensor data received from one or more sensors of an autonomous vehicle;
generate a trajectory of the autonomous vehicle based on the sensor data and a plurality of rules, wherein at least one of the plurality of rules corresponds to at least one of a plurality of costs, wherein generate the trajectory further comprises:
analyzing a plurality of nodes in a graph search of the trajectory based on the plurality of rules; and
generating the trajectory by minimizing a total cost associated with traversing along the trajectory;
generate a log of violations of the plurality of rules at one or more nodes along the trajectory, wherein the log includes explanations of the violations in a human readable language; and
transmit the log over a wireless communication channel to a remote computing device.

2. The autonomy computing system of claim 1, wherein the at least one processor is further programmed to generate the log by:
identifying a common parent node that has a first child node and a second child node, the common parent node and the first child node included in the trajectory, the second child node not included in the trajectory, the second child node having a lower cost than the first child node but having an end child node violating a rule having a priority higher than a rule violated by the first child node.

3. The autonomy computing system of claim 2, wherein the at least one processor is further programmed to generate the log by:
tracing back to the common parent node from the end child node; and
recording the violations between the common parent node and the end child node.

4. The autonomy computing system of claim 1, wherein a parent node has a first child node and a second child node, the parent node included in the trajectory, the first child node having a higher cost than the second child node, the at least one processor is further programmed to:
generate the trajectory by:
expanding the trajectory to include the first child node only if a child node of the second child node violates a rule having a higher priority than a rule violated by the first child node.

5. The autonomy computing system of claim 1, wherein the at least one processor is further programmed to:
transmit the log in real time.

6. The autonomy computing system of claim 1, wherein the at least one processor is further programmed to:
transmit a graph of the trajectory.

7. The autonomy computing system of claim 1, wherein the at least one processor is further programmed to:
generate the log by:
generating a plurality of violation sets; and
combining the plurality of violation sets into the log.

8. A method for controlling quality in planning a trajectory of an autonomous vehicle, the method comprising:
processing sensor data received from one or more sensors of an autonomous vehicle;
generating a trajectory of the autonomous vehicle based on the sensor data and a plurality of rules, wherein at least one of the plurality of rules corresponds to at least one of a plurality of costs, wherein generating the trajectory further comprises:
analyzing a plurality of nodes in a graph search of the trajectory based on the plurality of rules; and
generating the trajectory by minimizing a total cost associated with traversing along the trajectory;
generating a log of violations of the plurality of rules at one or more nodes along the trajectory, wherein the log includes explanations of the violations in a human readable language; and
transmitting the log over a wireless communication channel to a remote computing device.

9. The method of claim 8, wherein generating the log further comprises:
identifying a common parent node that has a first child node and a second child node, the common parent node and the first child node included in the trajectory, the second child node not included in the trajectory, the second child node having a lower cost than the first child node but having an end child node violating a rule having a priority higher than a rule violated by the first child node.

10. The method of claim 9, wherein generating the log further comprises:
tracing back to the common parent node from the end child node; and
recording the violations between the common parent node and the end child node.

11. The method of claim 8, wherein a parent node has a first child node and a second child node, the parent node included in the trajectory, the first child node having a higher cost than the second child node, generating the trajectory further comprising:
expanding the trajectory to include the first child node only if a child node of the second child node violates a rule having a higher priority than a rule violated by the first child node.

12. The method of claim 8, wherein transmitting the log further comprises:
transmitting the log in real time.

13. The method of claim 8, wherein transmitting the log further comprises:
transmitting a graph of the trajectory.

14. One or more non-transitory machine-readable storage media for controlling quality in planning a trajectory of an autonomous vehicle, comprising a plurality of instructions stored thereon that, in response to being executed, cause a system to:
process sensor data received from one or more sensors of an autonomous vehicle;
generate a trajectory of the autonomous vehicle based on the sensor data and a plurality of rules, wherein at least one of the plurality of rules corresponds to at least one of a plurality of costs, wherein generating the trajectory further comprises:
analyzing a plurality of nodes in a graph search of the trajectory based on the plurality of rules; and
generating the trajectory by minimizing a total cost associated with traversing along the trajectory;
generate a log of violations of the plurality of rules at one or more nodes along the trajectory, wherein the log includes explanations of the violations in a human readable language; and
transmit the log over a wireless communication channel to a remote computing device.

15. The one or more non-transitory machine-readable storage media of claim 14, wherein the plurality of instructions further cause the system to generate the log by:
identifying a common parent node that has a first child node and a second child node, the common parent node and the first child node included in the trajectory, the second child node not included in the trajectory, the second child node having a lower cost than the first child node but having an end child node violating a rule having a priority higher than a rule violated by the first child node.

16. The one or more non-transitory machine-readable storage media of claim 15, wherein the plurality of instructions further cause the system to generate the log by:
tracing back to the common parent node from the end child node; and
recording the violations between the common parent node and the end child node.

17. The one or more non-transitory machine-readable storage media of claim 15, wherein a parent node has a first child node and a second child node, the parent node included in the trajectory, the first child node having a higher cost than the second child node, the plurality of instructions further cause the system to generate the trajectory by:
expanding the trajectory to include the first child node only if a child node of the second child node violates a rule having a higher priority than a rule violated by the first child node.

18. The one or more non-transitory machine-readable storage media of claim 14, wherein the plurality of instructions further cause the system to:
transmit the log in real time.

19. The one or more non-transitory machine-readable storage media of claim 14, wherein the plurality of instructions further cause the system to:
transmit a graph of the trajectory.

20. The one or more non-transitory machine-readable storage media of claim 14, wherein the plurality of instructions further cause the system to:
generate the log by:
generating a plurality of violation sets; and
combining the plurality of violation sets into the log.
